(19) United States
(12) Patent Application Publication
(10) Pub. No.: US 2026/0119631 A1
(43) Pub. Date: Apr. 30, 2026

(54) SYSTEM, METHOD AND DEVICE FOR CONTINUOUS USER AUTHENTICATION AND VERIFICATION

(71) Applicants: Neelam Tiwari, Hyderabad (IN); Jyoti Prakash Mishra, Hyderabad (IN); Amit Shukla, Himachal Pradesh (IN)

(72) Inventors: Jyoti Prakash Mishra, Hyderabad (IN); Amit Shukla, Himachal Pradesh (IN)

(21) Appl. No.: 19/101,261

(22) PCT Filed: Jul. 2, 2024
(86) PCT No.: PCT/IB2024/056452

§ 371 Date: Feb. 5, 2025

(30) Foreign Application Priority Data
Jul. 9, 2023 (IN) 202341046105

(51) Int. Cl. G06F 21/32; G06F 21/31

(52) U.S. Cl. CPC G06F 21/32; G06F 21/316

(57) ABSTRACT

A single an electronic device (102) for authenticating and continuously verifying a user after authenticating the user is provided. The electronic device includes a memory storing program instructions; and a processing unit (114) coupled to the memory and operable to execute the program instructions, which, when executed by the processing unit, cause the electronic device to: capture behavioral biometrics (104) of the user while user is operating the electronic device, wherein the behavioral biometrics comprises at least a typing pattern of the user; extract attributes (106) associated with the typing pattern by pre-processing the captured behavioral biometrics; calculate timestamps associated with each of the extracted attributes; authenticate, by the processor, using a trained neural network model, the user when the calculated timestamps at least match with pre-determined timestamps associated with the user; and continuously perform, by the processor, the authenticating step until the user stops using the user terminal.

### TECHNICAL FIELD

The technology herein relates to authentication and verification systems. More particularly, the present invention relates to methods, devices and systems for continuous user authentication and verification based on key stroke data.

### BACKGROUND

Cybercrime is expected to skyrocket in the coming years. According to a Statista analysis, the cost of cybercrime globally is predicted to reach 23.82 trillion US dollars by 2027. According to a Sift report, Account Takeover (ATO) attacks are on the rise and surged by 132% in 2022. Every day, new cyber threats arise, and outdated security measures are increasingly failing. In today's world of increasingly sophisticated cyberattacks, traditional authentication techniques, such as multi-factor authentication, Mobile identity or authenticator apps are not strong enough. Organizations increasingly need cutting edge cybersecurity tools that offer persistent, adaptive authentication while also minimising administrative cost and user friction.

There are three methods of authenticating User identity: What you know: a password, pin, or answer to a secret question; What you have: a hardware security key, authentication app, or card reader; and What you are: a fingerprint, face scan, or behavioral trait. (Biometrics).

However, these authentication methods password, pin, secret question-answer, physiological biometrics are static, which making them more vulnerable to being stolen, scanned or photographed and then reconstructed for malicious use. Organizations increasingly need cutting-edge cybersecurity tools that offer persistent, adaptive authentication while also minimizing administrative cost and user friction.

When Cyber-Criminal gains access to a legitimate consumer account (stolen-credentials, brute-force, social-engg) results in an account takeover (ATO). Following are the sophisticated emerging cyber threats need to be addressed proactively: (i) Account Takeover (ATO) Threats (ii) New Account Opening Threats (iii) Remote Access Trojans (RAT) Threats (iv) Mobile Emulator Threats (v) Social Engineering Threats (vi) Malware Threats (vii) Insider Threats (viii) Password/Act Sharing Threats

### SUMMARY OF THE INVENTION

In the digital age, where personal information and sensitive data are increasingly stored and accessed online, the need for robust password security has become paramount. Traditional password-based authentication methods have been proven vulnerable to various attacks, including brute-force, dictionary, and social engineering techniques. As a result, researchers and developers have been continuously exploring innovative approaches to enhance password security and thwart unauthorized access.

One such promising technique is keystroking recognition, which leverages the unique typing patterns of individuals to establish their identity. keystroke dynamics refer to the distinct patterns and timing characteristics exhibited by an individual when typing on a keyboard or keypad. These patterns are influenced by factors such as finger size, muscle memory, and personal habits, making them difficult to replicate.

Neural networks, specifically deep learning models, have emerged as powerful tools for analyzing complex patterns and making accurate predictions. By training neural networks on large datasets of keystroke dynamics, it becomes possible to create robust models capable of recognizing individuals based on their typing patterns. This approach offers an additional layer of security, as it adds a behavioral element to the authentication process, making it significantly more challenging for adversaries to bypass.

By collecting keystroke data from a diverse set of users, the present invention builds and evaluates a neural network model capable of accurately distinguishing between legitimate users and potential imposters. The present inventio by virtue of keystroke recognition using neural networks provides a valuable addition to existing security measures, mitigating the risk of unauthorized access and reducing the reliance on static passwords. Furthermore, the present invention improves user experience by eliminating the need for complex, difficult-to-remember passwords, while still ensuring a high level of security. In the subsequent sections, we will delve into the methodology employed for data collection, pre-processing, and neural network architecture design.

Overall, the exploration of keystroke recognition using neural networks offers a promising avenue for enhancing password security. By leveraging the power of deep learning and the uniqueness of individual typing patterns, this approach has the potential to revolutionize authentication systems, providing users with a secure and seamless experience in the digital realm.

Accordingly, the present invention provides end-users protection from hacking and fraud without affecting the consumer experience. The present invention detects and prevents sophisticated cyber threats. The present invention operates as a human-computer interface framework to capture users'behavioral biometrics haptics (touch, pressure, keystrokes, gait, voice) which is capable of uniquely identifying individual users. By utilizing the present invention, it is impossible to duplicate or reconstruct these micro patterns, making it a very robust authentication system.

The present invention provides a behavioral biometric-based continuous monitoring system that verifies user's identities based on their passively observed behavioral biometrics data.

It provides a transparent, frictionless, and continuous monitoring system. Unlike conventional authentication techniques, which only authenticate when access is requested, behavioral biometrics technologies authenticate continuously by monitoring a user's continuing interactions with their mobile and computer in real time.

In an aspect, the present invention, on the basis of user behavior biometric data such as typing cadence, sliding movements and on-screen pressure (curve, angle, and distance ratio), the AI model of the present invention passively and transparently gets trained to create the user's behaviour profile which is capable of uniquely identifying individual user.

In an aspect, the present invention, following AI training, it records the new behaviour biometric parameters and compares them to the user's modelled profile. A decision is made based upon the similarity threshold on whether new parameters relate to a legitimate user or not.

In an aspect, the present invention silently and passively, monitoring the unique patterns that you display when performing specified acts, and learning to recognize you from the repetition of these micro-behaviours.

In an aspect, the behaviors biometrics-based authentication approach of the present invention focuses on “who you are” which differ in the conventional authentication approach that mainly relies on “what you have”or “what you know”.

In an aspect, the present invention uniquely builds a user identity and their respective risk score (AI Risk Engine) without impacting their digital journey. In an implementation, it can be appreciated that, the present invention for building a user identity and their respective risk score, it records the new behaviour biometric parameters and compares them to the user's modelled profile. A Risk Score would be generated based upon the similarity threshold on whether new parameters relate to a legitimate user or not.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates data collection process, in accordance with a preferred embodiment of the invention.

FIG. 2A illustrates an exemplary process of how values to the derived feature are provided based on the key-up-time and key-down-time, in accordance with a preferred embodiment of the invention.

FIG. 2B illustrates an exemplary Siamese network used for training purpose, in accordance with a preferred embodiment of the invention.

FIG. 3 illustrates an exemplary confusion matrix is created with the 2 different values when new 5 users'data is given as input the present invention, in accordance with a preferred embodiment of the invention.

FIG. 4 illustrates an exemplary an example computing device used for authenticating users, in accordance with a preferred embodiment of the invention.

FIG. 5 illustrates an exemplary table including example key stroke feature types and example feature values calculated from the key stroke data, in accordance with a preferred embodiment of the invention.

FIG. 6 illustrates an exemplary system block diagram for authenticating and continuously verifying a user after authenticating the user, in accordance with a preferred embodiment of the invention.

FIG. 7 illustrates an exemplary flowchart for authenticating and continuously verifying a user after authenticating the user, in accordance with a preferred embodiment of the invention.

FIG. 8 illustrates another exemplary flowchart for authenticating and continuously verifying a user after authenticating the user, in accordance with a preferred embodiment of the invention.

### DETAILED DESCRIPTION OF DRAWINGS

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The foregoing objects of the invention are accomplished and the problems and shortcomings associated with the prior art techniques and approaches are overcome by the present invention as described below in the preferred embodiment.

Embodiments of the present invention provides end-users protection from hacking and fraud without affecting the consumer experience. The present invention detects and prevents sophisticated cyber threats. The present invention operates as a human-computer interface framework to capture users'behavioral biometrics haptics (touch, pressure, keystrokes, gait, voice) which is capable of uniquely identifying individual users. By utilizing the present invention, it is impossible to duplicate or reconstruct these micro patterns, making it a very robust authentication system.

The present invention provides a behavioral biometric-based continuous monitoring system that verifies user's identities based on their passively observed behavioral biometrics data.

The present invention provides a transparent, frictionless, and continuous monitoring system. Unlike conventional authentication techniques, which only authenticate when access is requested, behavioral biometrics technologies authenticate continuously by monitoring a user's continuing interactions with their mobile and computer in real time.

The present invention, on the basis of user behavior biometric data such as typing cadence, sliding movements and on-screen pressure (curve, angle, and distance ratio), the AI model of the present invention passively and transparently gets trained to create the user's behaviors profile which is capable of uniquely identifying individual user.

The present invention, following AI training, it records the new behaviour biometric parameters and compares them to the user's modelled profile. A decision is made based upon the similarity threshold on whether new parameters relate to a legitimate user or not.

The present invention provides silently and passively, monitoring the unique patterns that you display when performing specified acts, and learning to recognize you from the repetition of these micro-behaviours.

The behaviors biometrics-based authentication approach of the present invention focuses on “who you are” which differ in the conventional authentication approach that mainly relies on “what you have”or “what you know”.

In an embodiment method, device and system for authentication and identification which re-verifies the user periodically without breaking the continuity of a session. Wearables such as smartwatches, glasses, fitness trackers, and medical devices keep track of day-to-day activities, motion, human biometric data such as heart rate, blood pressure. The sensing function of these devices can be used to create an initial identifying data set that can be used to continuously and transparently re-verify a user's identity throughout an entire session., In another embodiment, method, device and system for authenticating a user is provided that includes capturing, by a computing device, key stroke data generated as a result of a user typing content into the computing device, and calculating feature values from the key stroke data. The method also includes calculating distance scores from the feature values, calculating average distance scores from the distance scores, and entering the average distance scores into a classifier. The user is successfully authenticated when the classifier verifies the identity of the user.

In another embodiment, method, device and system for authenticating a user is provided that includes a processor and a memory configured to store data. The computing device is associated with a network and the memory is in communication with the processor. The memory has instructions stored thereon which, when read and executed by the processor, cause the computing device to capture key stroke data generated as a result of a user typing content into the computing device and to calculate feature values from the key stroke data. Moreover, the instructions when read and executed by the processor further cause the computing device to calculate distance scores from the feature values and average distance scores from the distance scores, enter the average distance scores into a classifier, and successfully authenticate the user when the classifier verifies the identity of the user.

In another embodiment, method, device and system for creating training samples is provided that includes calculating, by a computing device, from key stroke data of a user a plurality of feature values that each correspond to one of a plurality of key stroke feature types. Moreover, the method includes obtaining an enrollment template of the user that includes distance functions, and inputting each feature value into a respective distance function to calculate a set of distance scores for each key stroke feature type. Furthermore, the method includes averaging each set of distance scores to calculate an average distance score for each key stroke feature type, creating a vector from the average distance scores, and creating a training sample by combining the vector with a class value.

The vectors with a class value may be used to train an ensemble of ML-based classifiers in the security model. In one embodiment, the ensemble may include the following three classifiers: a Multilayer Perceptron (MLP) based classifier, a Support Vector Machine (SVM) based classifier, and an Adaptive Boosting (AdaBoost) based classifier.

The above embodiments would now be explained with the help of drawings:

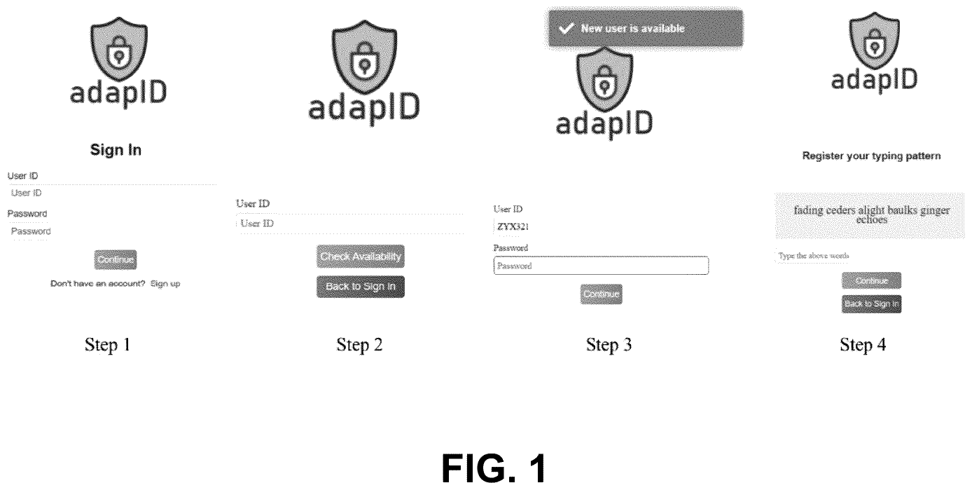

FIG. 1 illustrates data collection process, in accordance with a preferred embodiment of the invention. In an exemplary embodiment, user behaviors (Typing pattern) data is collected from the user browser via JS script. In order to examine the distinctive typing habits and develop a unique user profile, we have collected keystroke data via the web application. The entire process of data collection through web app is presented below with all the steps. The initial page for data collection is shown in FIG. 1. Every new user will create his profile by generating his unique User ID and password.

Step 1:—Login page:—The initial page for the data collection is shown in the first step of FIG. 1. Here, the user will make an account by clicking on the Sign-Up button. And if the user already has an account he can directly go to the step 4.

Step 2:—Sign Up:—Every user should have an identical user Id, So when a new user will come, first he will check the user ID he is going to use is available or not. He writes his user ID and the check availability button will light up and he can check the availability.

Step 3:—Profile Creation:—If the user ID is available a green message will appear and the user can choose password and can complete his profile generation.

Step 4:—Data collection/Capture typing pattern:—After completion of the profile generation, the text will appear in a grey box and this user will type the given text to the empty box given below. After completion of the text the ‘continue’ button will highlight and the user can go for the next sentence. All the typing information will save in the backend.

Once the data is collected this information send to the backend API. In the API we are doing data transformation (Data cleaning, pre-processing) then this transformed data is fed to AI model.

In an exemplary implementation, the raw data can be cleaned by applying a low-pass filter (2) and transformed into a proper format for the following stages. Incoming data can be used to extract a set of identification features of the user and inserted into a vector (3), hereinafter referred as a feature vector. The feature vector represents characteristics of the current user profile.

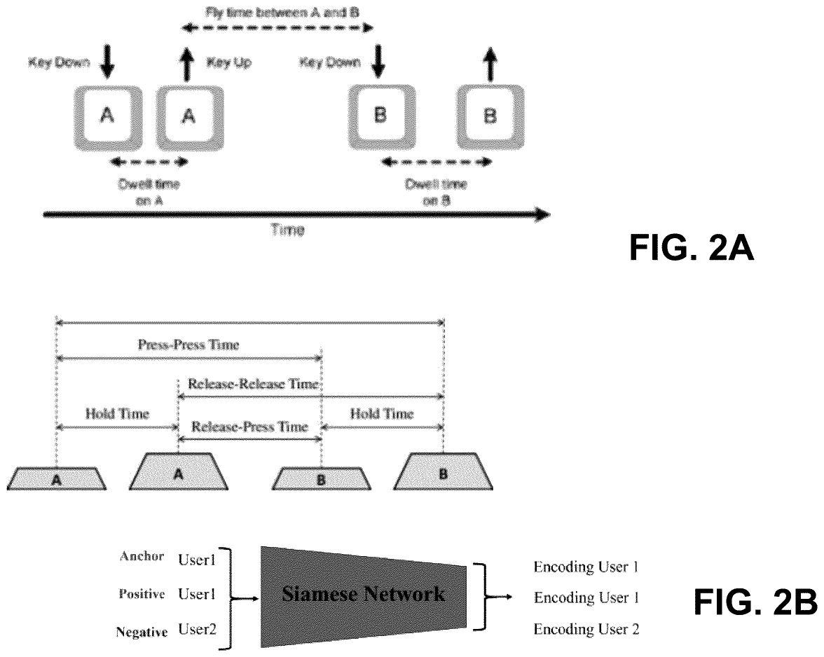

FIG. 2A illustrates an exemplary pre-processing of the data as to how values to the derived feature are provided based on the key-up-time and key-down-time, in accordance with a preferred embodiment of the invention.

After keystroke data was captured, we transformed the raw data to examine typing pattern elements including speed, rhythm, durations between key presses, and other pertinent factors. The following derived feature values were developed based on the key-up-time and key-down-time.

Based on the key down time ad key uptime following are the feature we are calculating
1. HL-Hold Latency
2. PL-Press Latency3. IL-Inter Key Latency
4. RL-Release Latency
1. HL: Hold Latency (HL): KeyUpTime (i)-KeyDownTime (i); ith keypress
i. Units: seconds
ii. Type: Float (miliseconds and microseconds)
a. Code: Hold Latency=round(keyup_time−Keydwn_time).i. total_seconds(),3)
2. PL:
a. Press Latency (PL): KeyDownTime(i+1)-KeyDownTime(i); I'th keypress
i. If I is the last key, PL=0.0
ii. Units: Seconds
iii. Type: Float (miliseconds and microseconds)
b. Code:
i. Press_layency=round((next_keydown_time−Keydown_time).total_seconds(), 3)
3. IL:
a. InterKey Latency (IL): KeyDownTime(i+1)-KeyUpTime(i); I'th keypress
i. If I is the last key, RL=0.0
ii. Units: Seconds
b. Code:
i. interKey_latency=round((next_KeyDown_Time−KeyUp_Time).total_Seconds(), 3)
4.RL:
a. Release Latency (RL): KeyUpTime(i+1)-KeyUpTime(i); I'th KeyPress
i. If I is the last key, RL=0.0
ii. Units: Seconds
iii. Type: Float (milliseconds and microseconds)
b. Code:
i. Release_latency=round((next_keyup_time−keyup_time).total_seconds(), 3)

Based on the pressed key we are doing one-hot encoding. As of now users are allowed to enter only small case alphabet. For the particular pressed key we are concerting th key into Upper case then calculating its respected ACSII value.

Following are the special key we are considering1. SHIFT (16 ASCII value), 2. BACKSPACE (8 ASCII value), 3. SPACE (32 ASCII value), 4. CAPSLOCK (20 ASCII value). New feature columns are ‘Key8’, ‘Key 16’, ‘Key20’, ‘Key32’, ‘Key65’, . . . , ‘Key90’, In case if Pressed Key is ‘b’ ‘Key66 has a value of 1 (One). Remaining Key values are filled with 0 (Zero).

The captured transformed keystroke data undergoes pre-processing to eliminate noise and outliers, ensuring the accuracy and reliability of subsequent analysis. This step may also involve techniques such as data normalization and feature extraction to prepare the data for further processing.

FIG. 2B illustrates an exemplary Siamese network used for training purpose, in accordance with a preferred embodiment of the invention. The deep learning architecture used for keystroke biometric training leverages the ability of neural networks to learn complex patterns and generalize from data. By capturing the subtle timing characteristics of an individual's typing style, the model can distinguish between genuine users and unauthorized individuals attempting to mimic their typing behaviour.

A suitable deep learning architecture is chosen for Modeling and training the keystroke biometric system. Recurrent Neural Networks (RNNs) and Convolutional Neural Networks (CNNs) are commonly used due to their ability to capture temporal dependencies and spatial patterns, respectively. Variants like Long Short-Term Memory (LSTM) and Gated Recurrent Units (GRU) are often employed for their memory and sequence Modeling capabilities.

In the present invention, RNN based encoder network is implemented that takes key stroke data as input and will give an encoding. A Simaese Network architecture with the RNN layers is trained to identify and distinguish the user and non-users. The architecture of a Siamese network consists of two identical subnetworks (also known as twin networks) that share the same weights and architecture. Each subnetwork processes one input, and the outputs from both subnetworks are compared to measure their similarity or dissimilarity. It takes a pair of input samples as its input. These samples could be images, text sequences, or any other type of data. In the present invention, input data is text encoding. The two identical subnetwork are identical here. The consist of multiple layers, such as convolutional layers, fully connected layers or recurrent layers, depending on the nature of the input data. The purpose of these shared subnetwork is to extract meaningful feature representations from the inputs. Each subnetwork independently processes its input through the shared layers, transforming the input into a lower-dimensional feature representation that captures the relationship or similarity between the two inputs.

The output feature representations from the two subnetworks are combined using a merge operation. This operation could be a simple concatenation, element-wise subtraction, or any other suitable method for the specific task at hand. The goal is to create a single representation that captures the relationship or similarity between the two inputs.

The merged representation is then passed through additional layers, typically fully connected layers, to calculate a similarity or dissimilarity score between the input pair. This score represents the distance or similarity measurement between the two inputs based on the learned representations.

During training, a loss function is defined based on the desired task. For example, in tasks such as face recognition or signature verification, a contrastive loss or triplet loss can be used. These loss functions encourage the Siamese network to learn representations that place similar inputs closer together in the learned feature space and dissimilar inputs farther apart. Once the Siamese network is trained, it can be used for inference. Given a new pair of inputs, the network computes their feature representations using the shared subnetworks and calculates the distance or similarity score between them. This score can be used for various tasks such as image matching, object tracking, or even sentiment analysis.

Model Training:—For training the data is split into training and validation sets. The model is then trained using the training data set. During the training the model will learn to recognize the unique typing pattern of each individual by adjusting its internal parameters (weights and biases) through an optimization algorithm such as gradient descent. The objective to minimize the losses function that quantifies the difference between predicted and actual keystroke patterns. While training the network will ultimately tries to minimize the Euclidean distance for the same user pattern and will increase the distance for different users.

Model Valuation:—The trained model is evaluated using the validation set to assess its performance. Various metrics, such as accuracy, false acceptance rate (FAR), and false rejection rate (FRR), are calculated to determine the model's effectiveness in identifying authorized users and rejecting impostors.

False Acceptance Rate— 0/50 (0.0001%), False Rejection Rate—( 5/50=10%)

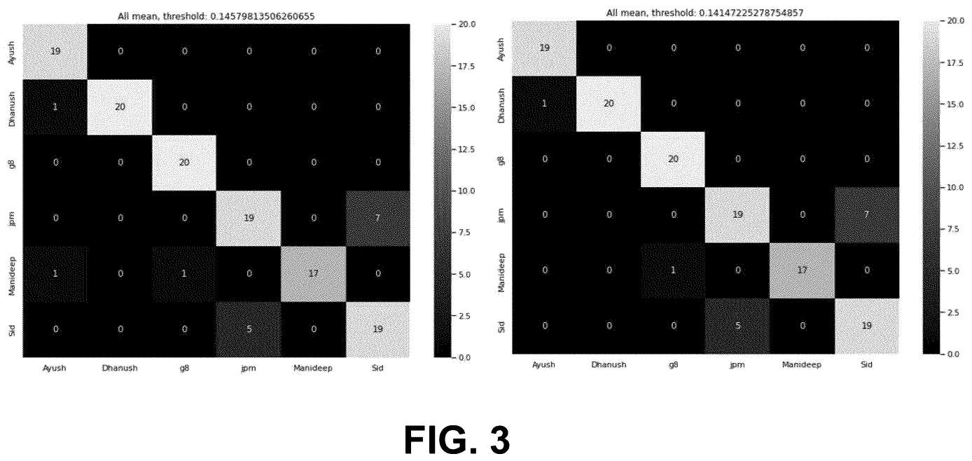

Testing Results:—Once the model demonstrates satisfactory performance, it can be tested on new, unseen data to evaluate its generalization ability. Finally, the trained model can be deployed in a real-world system, where it analyses keystroke patterns of users during authentication attempts and provides a decision on their legitimacy. New 5 users'data is given to the model and the confusion matrix is created with the 2 different values FIG. 3 illustrates an exemplary confusion matrix is created with the 2 different values when new 5 users'data is given as input the present invention, in accordance with a preferred embodiment of the invention.

The present invention can be implemented in following use cases:

Detect and Prevent Account Takeover(ATO) attacks: Using stolen username and passwords, an attacker can gain access to a secured ecosystem. adapID uses AI algorithms and behavioural biometrics to ensure that only legitimate user is able to access to the secured ecosystem.

Detect and Prevent Remote Access Trojans (RAT) attacks: With its inherent capabilities to distinguish bots (machines) and human beings, our behavior biometric offering can prevent unauthorized users to access organization services both remotely and locally. Behavioral Biometrics can make sure that only intended users are actually using a system at any given time.

Prevent Account/Password Sharing: A common security risk is the informal sharing of named accounts. Behavioral biometrics systems are able to distinguish between intended users and other users even when login credentials are being submitted, and they can restrict authentication in accordance with that distinction.

Zero Trust Security: With Continuous Verification, prevent unauthorized users from accessing the company's ecosystems. Continuously monitor and analyses user activity across login and transaction sessions by their typing, swiping or tapping pattern. If an unauthorized typing/swiping pattern is detected, instantly locks the company desktop, laptop or mobile device to protect critical data.

Protect from Insider Threat: Internal dangers can arise from users who unintentionally get access to other systems as a result of oversights in privileged access control. Using behavioral biometrics, it is possible to guarantee that only authorized users are actually using a system at any given time.

The present invention provides smart threat detection and prevention system has numerous novelties. The static nature of conventional authentication techniques like passwords, pins, secret questions, and physiological biometrics makes them more vulnerable to being stolen, scanned, or photographed, then reconstructed for malicious uses. Behavioral biometrics patterns like as typing, swiping, or even mouse behaviors are impossibly challenging and extremely difficult to recreate for malicious purposes. One of the Key feature of behavioral biometric authentication is continuous monitoring the micro-patterns in users'behaviors. It protects organization endpoints sessions invisibly, as users work.

Unlike conventional authentication techniques, which only authenticate when access is requested, behavioral biometrics technologies authenticate continuously by monitoring a user's ongoing interactions with their Mobile and computer in real time.

Inherent capabilities of the present invention enable distinguish bots (Machines) and human beings, can detect and prevent automated unauthorized bot attacks from accessing an organization's ecosystem.

It offers end users a transparent, frictionless and invisible journey by creating an unique user identity and the respective risk score without impacting their digital journey. Artificial Intelligence (AI) and Machine Learning (ML) algorithms are used to process this regularly collected massive user's behavioral biometrics data in order to swiftly and precisely detect cyber threats. Instead of relying just on one point of comparison, behavioral biometric authentication continuously examines your data over time in the background. This means that in addition to having a large data sample to compare your login attempts against, the system also has the capability of adapting over time as your behaviors changes.

And because the technology is silent, it can study the micropatterns that you exhibit in your activity and create a profile of your particular actions without interfering with user daily activities.

It's incredibly precise, highly secure, and frictionless, making it the ideal solution for organizations looking to balance security with a great user experience.

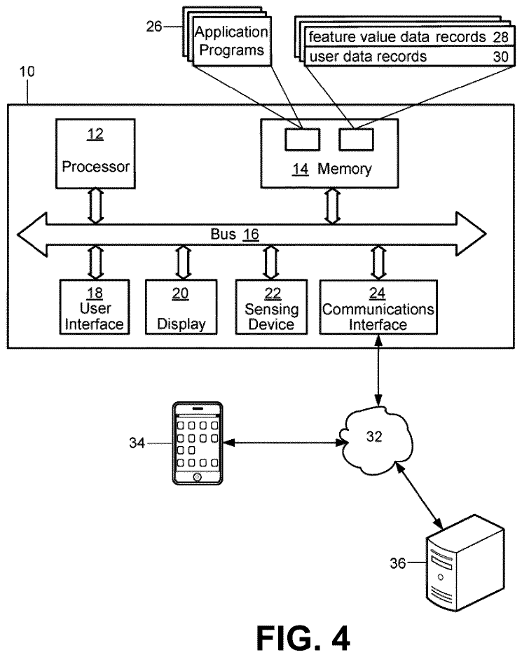

FIG. 4 illustrates an exemplary an example computing device used for authenticating users, in accordance with a preferred embodiment of the invention. The computing device 10 includes components such as, but not limited to, one or more processors 12, a memory 14, a bus 16, a user interface 18, a display 20, a sensing device 22 and a communications interface 24. General communication between the components in the computing device 10 is provided via the bus 16.

The computing device 10 may be any device capable of performing the functions described herein. One example of the computing device 10 is a personal computer (PC). Other examples of the computing device 10 include, but are not limited to, a smart phone, a tablet computer, a phablet computer, a laptop computer, and any type of device having wired or wireless networking capabilities such as a personal digital assistant (PDA). When the computing device 10 is a portable device like a smart phone, the components of the computing device 10 may also include a gyroscope (not shown), an accelerometer (not shown), and a magnetometer (not shown) that generate data as the computing device 10 is operated.

The processor 12 executes instructions, or computer programs, stored in the memory 14. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing at least a portion of the functions and/or methods described herein. The above examples are not intended to limit in any way the definition and/or meaning of the term “processor.”

As used herein, the term “computer program” is intended to encompass an executable program that exists permanently or temporarily on any non-transitory computer-readable recordable medium that causes the computing device 10 to perform at least a portion of the functions and/or methods described herein. Application programs 26, also known as applications, are computer programs stored in the memory 14. Application programs 26 include, but are not limited to, an operating system, an Internet browser application, enrollment applications, authentication applications, applications that use pre-trained models based on machine learning algorithms, and any special computer program that manages the relationship between application software and any suitable variety of hardware that helps to make-up a computer system or computing environment.

Authentication applications enable the computing device 10 to conduct authentication transactions with any type of authentication data. Authentication transactions include verification transactions and identification (1:N) transactions, where “N” is a number of candidates. The process of verifying the identity of a user is a verification transaction.

Machine learning algorithm applications include at least classifiers and regressors. Machine learning algorithms may process data to generate a classification model. For example, a machine learning algorithm may process key stroke data to train a classifier which may be used to facilitate verifying user identities during authentication transactions. Examples of such machine learning algorithms include, but are not limited to, support vector machine learning algorithms, linear discriminant analysis learning algorithms, and artificial neural network learning algorithms. The memory 14 may be any non-transitory computer-readable recording medium used to store data including, but not limited to, computer programs, feature value data records 28, and user data records 30. Each user is associated with a set of feature value data records 28. The set of feature value data records 28 for a user stores feature values for that user only. Each feature value data record in the set of records 28 for a user corresponds to a different feature.

The user data record 30 for each user may include key stroke data, classifier training samples, record templates and personal data of the user. The keystroke data may be captured during an enrollment process, while training a classifier, or during authentication transactions. Key stroke data captured during the enrollment process may be processed to generate an enrollment template for the user. As described herein, templates comprise a list of distance functions which are used to facilitate verifying the identities of users during authentication transactions.

Key stroke data is generated when keys corresponding to the characters of content are pressed and released on a physical keyboard or a mobile device virtual keyboard. Content may be any information required by a website or by an application 26 running on the computing device 10. Examples of content include, but are not limited to, usernames, passwords, credit card numbers, email addresses and telephone numbers. Moreover, content may be any word, or any other combination of letters, numbers, special characters, and altering keys. Content may be specific to the user typing the content.

The same or different content may be typed to make a purchase from a merchant via the network 32 versus conducting a financial transaction with a financial institution via the network 32. Content may be entered into the computing device 10 for reasons other than conducting network-based transactions. For example, content may be entered into the computing device 10 in order to unlock the computing device 10 or to access restricted data stored on the computing device 10.

Personal data includes any demographic information regarding a person such as, but not limited to, a person's name, gender, age, date-of-birth, address, citizenship and marital status. Each user data record 30 may also include any kind of data that may be used to enhance the accuracy and trustworthiness of authentication transaction results generated by classifiers as described herein.

An authentication data requirement is the data desired to be captured from a user during either a verification or identification transaction. For the example methods described herein, the authentication data requirement is key stroke data. Additionally, or alternatively, the authentication data requirement may include any other data that can be obtained that is related to typing data into a physical keyboard or mobile device virtual keyboard. Such other data may include data generated by the accelerometer (not shown), gyroscope (not shown), and magnetometer (not shown) included in a portable device like a smart phone.

Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writable or re-writable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like. Furthermore, the non-transitory computer-readable recording media may be implemented as smart cards, SIMs, any type of physical and/or virtual storage, or any other digital source such as a network or the Internet from which a computing device can read computer programs, applications or executable instructions.

The user interface 18 and the display 20 allow interaction between a user and the computing device 10. The display 20 may include a visual display or monitor that displays information to a user. For example, the display 20 may be a Liquid Crystal Display (LCD), active-matrix display, plasma display, or cathode ray tube (CRT). The user interface 18 may include a keypad, a keyboard, a mouse, an infrared light source, a microphone, cameras, and/or speakers.

The user interface 18 and the display 20 may be integrated into a touch screen display. Accordingly, the display may also be used to show a graphical user interface, which can display various data and provide “forms” that include fields that allow for the entry of information by the user. Touching the screen at locations corresponding to the display of a graphical user interface allows the user to interact with the device 10 to enter data, change settings, control functions, etc.

Consequently, when the touch screen is touched, the user interface 18 communicates this change to the processor 12, and settings can be changed or user entered information can be captured and stored in the memory 14. The sensing device 22 may include Radio Frequency Identification (RFID) components or systems for receiving information from other devices. The sensing device 22 may also include components with Bluetooth, Near Field Communication (NFC), infrared, or other similar capabilities. The computing device 10 may alternatively not include the sensing device 22.

The communications interface 24 provides the computing device 10 with two-way data communications. Moreover, the communications interface 24 enables the computing device 10 to conduct wireless communications such as cellular telephone calls and to wirelessly access the Internet over a network 32. By way of example, the communications interface 24 may be a digital subscriber line (DSL) card or modem, an integrated services digital network (ISDN) card, a cable modem, or a telephone modem to provide a data communication connection to a corresponding type of telephone line. As another example, the communications interface 24 may be a local area network (LAN) card (e.g., for Ethernet™ or an Asynchronous Transfer Model (ATM) network) to provide a data communication connection to a compatible LAN. As yet another example, the communications interface 24 may be a wire or a cable connecting the computing device 10 with a LAN. Further, the communications interface 24 may include peripheral interface devices, such as a Universal Serial Bus (USB) interface, a PCMCIA (Personal Computer Memory Card International Association) interface, and the like. Thus, it should be understood the communications interface 24 may enable the computing device 10 to conduct any type of wireless or wired communications such as, but not limited to, accessing the Internet. Although the computing device 10 includes a single communications interface 24, the computing device 10 may alternatively include multiple communications interfaces 24.

The communications interface 24 also allows the exchange of information across the network 32. The exchange of information may involve the transmission of radio frequency (RF) signals through an antenna (not shown). Moreover, the exchange of information may be between the computing device 10 and a computing device 34 associated with a different user and a computer system 36 capable of communicating over the network 32. Although one computing device 34 and one computer system 36 are illustrated in FIG. 1, it should be understood that any number of computing devices 34 and any number of computer systems 36 may communicate via the network 32 with the computing device 10 and with any other computing devices 34 (not shown) and any other computer systems 36 (not shown) operable to communicate over the network 32.

The computing device 34 associated with a user and each computer system 36 includes components and applications similar to those described herein for the computing device 10. As a result, the computing device 34 associated with each user and each computer system 36 may perform the same functions described herein for the computing device 10.

The computing devices 34 at least capture and process key stroke data generated by users as a result of typing on the computing device 34 and generates data as a user operates the computing device 34. The key stroke data is captured by the computing device 34 of a user when content is typed via the user computing device 34 into a website, email application 26, or any other type of application 26 that may be run by the computing device 34 associated with a user. A user as described herein is a person who types on a physical keyboard or a mobile device virtual keyboard. A mobile device virtual keyboard may be displayed by, for example, a smart phone, a tablet computer, a laptop, and like devices.

The network 32 may be a 5G communications network. Alternatively, the network 32 may be any wireless network including, but not limited to, 4G, 3G, Wi-Fi, Global System for Mobile (GSM), Enhanced Data for GSM Evolution (EDGE), and any combination of a LAN, a wide area network (WAN) and the Internet. The network 32 may also be any type of wired network or a combination of wired and wireless networks.

Example computing devices 34 include, but are not limited to, smart phones, tablet computers, phablet computers, laptop computers, personal computers and cellular phones. Each computing device 34 is typically associated with a different user. Alternatively, or additionally, a computing device 34 may be associated with any individual or with any type of entity including, but not limited to, commercial and non-commercial entities. A computing device 34 may be associated with a user in many different ways. For example, the computing device 34 may belong to the user's employer and be operated by the user or it may be a personal computing device 34 owned and operated by the user. Example computer systems 36 include computer systems of service providers such as, but not limited to, financial institutions, medical facilities, national security agencies, merchants, and authenticators. The computing devices 10, 34 and the computer systems 36 may alternatively be referred to as information systems.

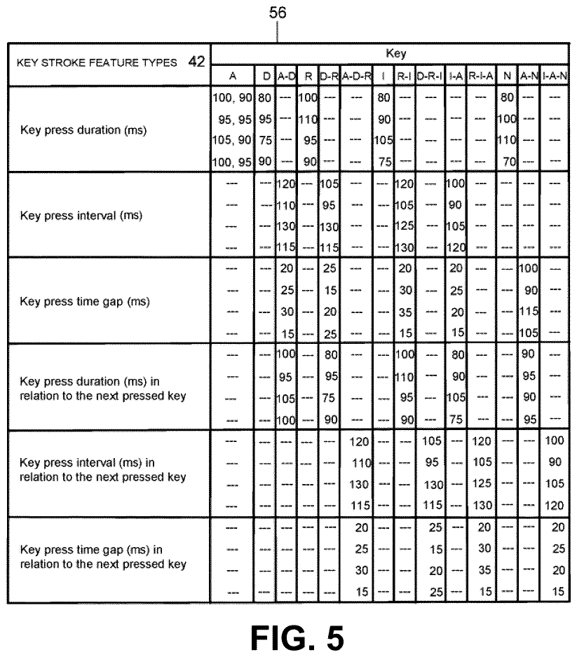

FIG. 5 illustrates an exemplary table including example key stroke feature types and example feature values calculated from the key stroke data, in accordance with a preferred embodiment of the invention. In an exemplary embodiment, a key stroke timeline illustrating example key stroke data generated as a result of using the computing device associated with a user to type content during an enrollment process. For the example timeline, the computing device is a PC and the example content is “Adrian” typed on the touchpad of the phone. The timeline begins at the time the key corresponding to the first letter in the content is pressed and ends when the key corresponding to the last letter in the content is released. More specifically, the timeline begins at time t=0 seconds when the key corresponding to the letter “A” is pressed and ends at time t=625 milliseconds (ms) when the key corresponding to the letter “N” is released. The key corresponding to the letter “A” is referred to herein as the “A” key, the key corresponding to the letter “D” is referred to herein as the “D” key, the key corresponding to the letter “R” is referred to herein as the “R” key, and so on. Key stroke data includes the character of the pressed key as well as the times at which the key was pressed and released. For the key stroke timeline, the key stroke data is as follows: for the first “A” key, press time was at time t=0 seconds and release time was at t=100 milliseconds (ms); for the “D” key, press time was at time t=120 ms and release time was at time t=200 ms; for the “R” key, press time was at time t=225 ms and release time was at 325 ms; for the “I” key, press time was at time t=345 ms and release time was at time t=425 ms; for the second “A” key, the press time was at time t=445 ms and release time was at time t=535 ms; and for the “N” key, press time was at 545 ms and release time was at time t=625 ms.

Although the key stroke timeline reflects key strokes typed during an enrollment process, other key stroke timelines including key stroke data different from that in the timeline may be generated during at least different training processes and during authentication process.

The key press duration is the time during which a key is pressed while a user is typing so is calculated as the difference between the press and release times of a key. The key press duration requires a single key be typed while the other key stroke feature types require at least two. The key press interval is the time between pressing two consecutive keys from the start of pressing one key to the start of pressing a next key so is calculated as the difference between the press times of two consecutive keys. The keys may be for the same or different characters. The key press time gap is the time between releasing a currently pressed key and pressing the next key so is calculated as the difference between the release time of the currently pressed key and the press time of the next pressed key. It is possible for the key press time gap to be a negative value because a user may press the next key before releasing the currently pressed key which is considered press overlap. The key press duration for one key in relation to the next pressed key is the same as the key press duration for one key; however, the key press duration data is stored separately for each different next pressed key. The key press interval in relation to the next pressed key is the same as the key press interval; however, the key press interval data is stored separately for each different next pressed key. Lastly, the key press time gap in relation to the next pressed key is the same as the key press time gap; however, the key press time gap data is stored separately for each different next pressed key.

The feature value for the key press duration of the “A” key is calculated as the difference between the press and release times of the “A” key, that is, 100 ms−0 ms=100 ms. Thus, the example feature value for the key press duration of the letter “A”is 100 ms.

FIG. 5 provides an example table 56 showing feature values calculated as a result of entering the content four times during the enrollment process. Each feature for which feature values were calculated includes four feature values. However, the key press duration of the “A” key has eight feature values because the “A” key is pressed and released twice each time the content “Adrian” is typed. The feature values shown in the table 56 may be stored in the feature value data record of the user for the corresponding feature. For example, the feature values calculated for the key press time gap between the “A” and “D” keys may be stored in the feature value data record of the user corresponding to the key press time gap between the “A” and “D” keys. Although the table 56 includes feature values calculated as a result of entering the content four times, the table 56 may alternatively include feature values calculated as the result of entering the content any number of times. The greater the number of entries, the greater the amount of data that may be used to describe user typing characteristics.

A distance function is created for each respective feature based on the feature values calculated for the respective feature. Thus, for example, the distance function for the key press duration of the “A” key is created based on eight feature values. The distance function for each other feature is created based on four feature values. The distance functions calculated based on key stroke data captured during the enrollment process are used to create the enrollment template for that user.

Distance functions may be computed using a kernel density estimator approach, where kernels centered on each feature value are accumulated. Any other metric or method to create distance functions can be used, for example a mixture of Gaussian functions, Mahalanobis, Euclidian or Manhattan distances may be used. The distance functions described herein calculate distance scores between the range of zero and one hundred. However, the distance functions may alternatively calculate distance scores within any range that facilitates training classifiers that are capable of generating accurate and trustworthy authentication transaction results.

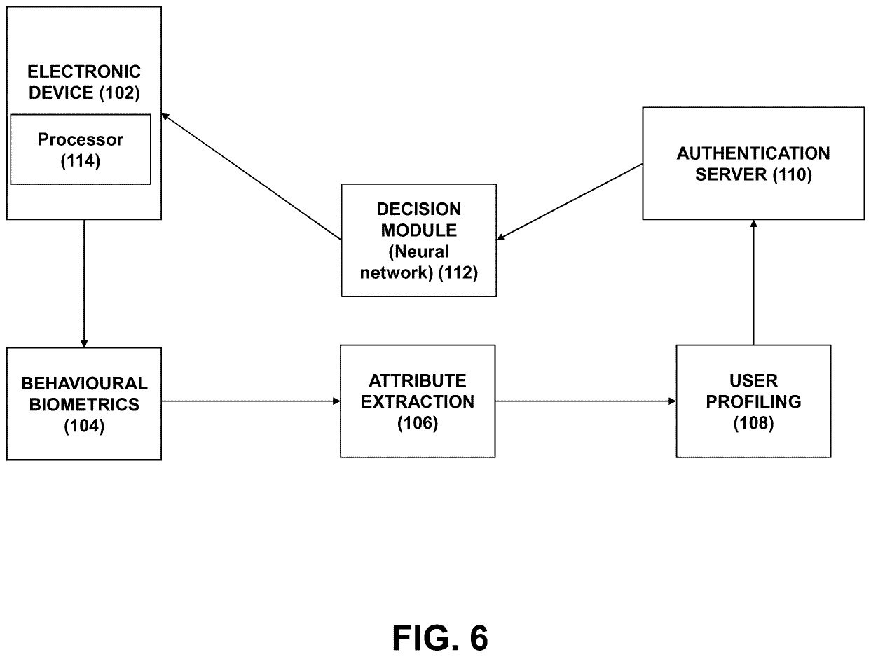

FIG. 6 illustrates an exemplary system block diagram for authenticating and continuously verifying a user after authenticating the user, in accordance with a preferred embodiment of the invention.

In an embodiment, a system for authenticating and continuously verifying a user after authenticating the user is provided. The system includes an electronic device (102); an authentication server (110); and a non-transitory computer-readable medium, in operable communication with the electronic device and the authentication server, for performing a training phase and an authentication phase.

The training phase includes capturing, by a processor of the electronic device, first behavioral biometrics (104) of the user while user is operating the electronic device, wherein the behavioral biometrics comprises at least a typing pattern of the user; extracting, by the processor, attributes (106) associated with the typing pattern by pre-processing the captured first behavioral biometrics; generating a first user profile (108) based upon the extracted attributes wherein the first user profile comprising timestamps associated with each of the extracted attributes; transmitting, by a transmitting device of the electronic device, the first user profile to the authentication server (110).

The authentication phase includes detecting that the electronic device is being accessed by the user; capturing, by the processor (114) of an electronic device, second behavioral biometrics of the user while user is operating the electronic device, wherein the second behavioral biometrics (106) comprises at least a typing pattern of the user; extracting, by the processor, attributes (108) associated with the typing pattern by pre-processing the captured second behavioral biometrics; receiving, by the electronic device, the first user profile (110) from the authentication server; comparing (112) the first user profile to the extracted attributes from the captured second behavioral biometrics; suspending the electronic device access if the first user profile does not match the extracted attributes from the captured second behavioral biometrics; or permitting the user to maintain access to the electronic device if the first user profile matches the extracted attributes from the captured second behavioral biometrics; and continuously executing the authentication phase until the user stops using the electronic device.

In an exemplary embodiment, the typing pattern of the user comprise users'behavioral biometrics haptics of the use; wherein the users'behavioral biometrics haptics comprise of touch, pressure, keystrokes, gait, voice, cadence, sliding movements and on-screen pressure selected from curve, angle, and distance ratio; and wherein the attributes are selected from speed, rhythm, durations between key presses, and other pertinent factors.

In another embodiment, an electronic device (102) for authenticating and continuously verifying a user after authenticating the user is provided. The electronic device includes a memory storing program instructions; and a processing unit (114) coupled to the memory and operable to execute the program instructions, which, when executed by the processing unit, cause the electronic device to: capture behavioral biometrics (104) of the user while user is operating the electronic device, wherein the behavioral biometrics comprises at least a typing pattern of the user; extract attributes (106) associated with the typing pattern by pre-processing the captured behavioral biometrics; calculate timestamps associated with each of the extracted attributes; authenticate, by the processor, using a trained neural network model, the user when the calculated timestamps at least match with one or more pre-determined timestamps associated with the user; and continuously perform, by the processor, the authenticating step until the user stops using the user terminal.

In an exemplary embodiment, the typing pattern of the user comprise users'behavioral biometrics haptics of the use.

In an exemplary embodiment, the users'behavioral biometrics haptics comprise of touch, pressure, keystrokes, gait, voice, cadence, sliding movements and on-screen pressure selected from curve, angle, and distance ratio.

In an exemplary embodiment, the attributes are selected from speed, rhythm, durations between key presses, hold latency, press latency, inter key latency, release latency, special-keys-typing-pattern.

In an exemplary embodiment, the processing unit is configured for training a plurality of machine learning-based classifiers in a machine learning (ML) model (112) based on the extracted attributes associated with the typing pattern.

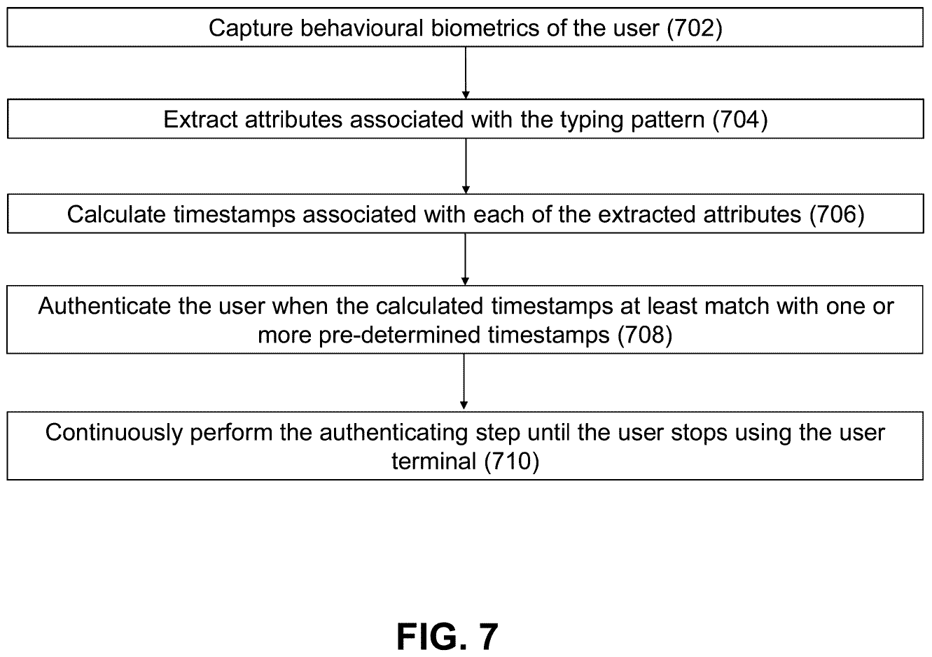

FIG. 7 illustrates an exemplary flowchart for authenticating and continuously verifying a user after authenticating the user, in accordance with a preferred embodiment of the invention. At step 702, a processor of an electronic device captures behavioral biometrics of the user while user is operating the electronic device. The first behavioral biometrics comprises at least a typing pattern of the user. The typing pattern of the user comprise users'behavioural biometrics haptics of the user.

At step 704, the processor extracts attributes associated with the typing pattern by pre-processing the captured behavioural biometrics. The users'behavioural biometrics haptics comprise of touch, pressure, keystrokes, gait, voice, cadence, sliding movements and on-screen pressure selected from curve, angle, and distance ratio.

At step 706, the processor calculates timestamps associated with each of the extracted attributes. The attributes are selected from speed, rhythm, durations between key presses, and hold latency, press latency, inter key latency, release latency, special-keys-typing-pattern. In an example, the timestamps are associated with pressing and release of each key on a data input device (such as a touchpad) by the first user during the log-in. The timestamps of all clicks of the pointing device by the first user from beginning to end of the log-in. The click times—here, the timestamps of all clicks of the pointing device by the participant from beginning to end of the log-in—provide an approximation of how long the user takes to log-in. In calculating this log-in duration, a simple assumption was made that the first click of a mouse is to enter the username field, while the last one is to submit the entered credentials. In this manner, the total log-in time was extracted as a relevant feature from the timestamped click patterns. In another example, the timestamp may be associated with the “dwell time” refers to the time a key remains pressed, and the “flight time” refers to the time between a key goes “up” and the next key goes “down”. The flight and dwell times may be extracted from the timestamps associated with pressing and release of each key (on a data input device) by the participant during the log-in At step 708, the processor authenticates, using a trained neural network model, the user when the calculated timestamps at least match with one or more pre-determined timestamps associated with the user.

At step 710, the processor continuously performs the authenticating step until the user stops using the user terminal.

The processor further trains a plurality of machine learning-based classifiers in a machine learning (ML) model based on the extracted attributes associated with the typing pattern.

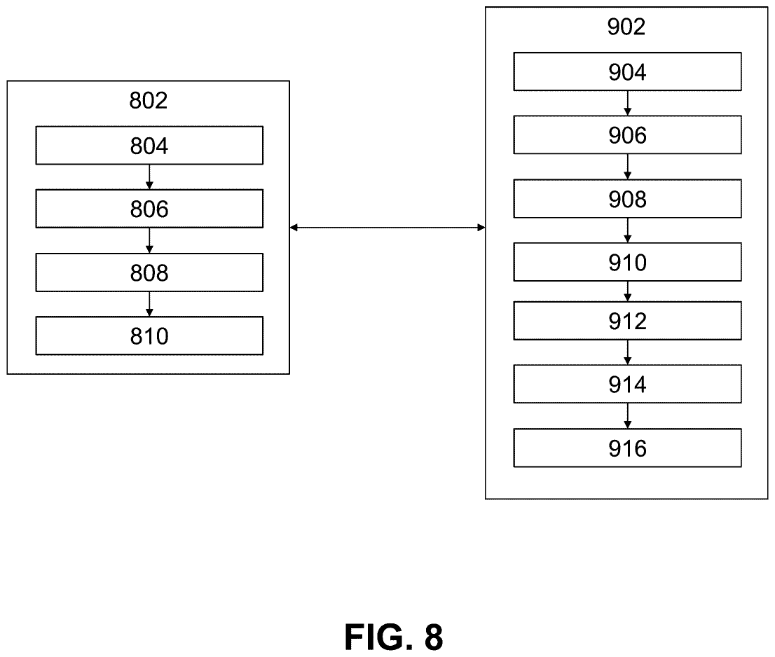

FIG. 8 illustrates another exemplary flowchart for authenticating and continuously verifying a user after authenticating the user, in accordance with a preferred embodiment of the invention. The method preforms the performs a training phase (802) and an authentication phase (902).

At step 804, a processor of an electronic device captures first behavioural biometrics of the user while user is operating the electronic device. The behavioural biometrics comprises at least a typing pattern of the user. In an example, the behavioural biometrics may include mouse movements and keystrokes. As a result, features extracted from the client's behavioral biometrics analyze mouse movements identify 8 classes into which each mouse event can be classified into, based on the relative direction of mouse movement. On the other hand, keystroke biometrics mostly focus on dwell time (the time a key remains pressed) and flight time (the time between “key up”and the next “key down”).

At step 806, the processor extracts attributes associated with the typing pattern by pre-processing the captured first behavioural biometrics. At step 808, the processor generates a first user profile based upon the extracted attributes, wherein the first user profile comprising timestamps associated with each of the extracted attributes. At step 810, a transmitting device of the electronic device transmits the first user profile to an authentication server. At step 904, the processor of the electronic device captures second behavioural biometrics of the user while user is operating the electronic device, wherein the second behavioural biometrics comprises at least a typing pattern of the user. This step is performed when the processor detects that the electronic device is being accessed by the user. At step 906, the processor extracts attributes associated with the typing pattern by pre-processing the captured second behavioural biometrics. At step 908, the processor receives the first user profile from the authentication server. At step 910, the processor compares the first user profile to the extracted attributes from the captured second behavioural biometrics. At step 912, the processor suspends the electronic device access if the first user profile does not match the extracted attributes from the captured second behavioural biometrics. At step 914, the processor permits the user to maintain access to the electronic device if the first user profile matches the extracted attributes from the captured second behavioural biometrics. At step 916, the processor continuously executes the authentication phase until the user stops using the electronic device.

While the subject invention is described and illustrated with respect to certain preferred and alternative embodiments, it should be understood that various modifications can be made to those embodiments without departing from the subject invention, the scope of which is defined in the following claims.

We claim:

1. A method for authenticating and continuously verifying a user after authenticating the user, the method comprising:
capturing (702), by a processor of an electronic device, behavioural biometrics of the user while user is operating the electronic device, wherein the first behavioural biometrics comprises at least a typing pattern of the user;
extracting (704), by the processor, attributes associated with the typing pattern by pre-processing the captured behavioural biometrics;
calculating (706), by the processor, timestamps associated with each of the extracted attributes;
authenticating (708), by the processor, using a trained neural network model, the user when the calculated timestamps at least match with one or more pre-determined timestamps associated with the user; and
continuously performing (710), by the processor, the authenticating step until the user stops using the user terminal.

2. The method as claimed in claim 1, wherein the typing pattern of the user comprise users'behavioural biometrics haptics of the user;
wherein the users'behavioural biometrics haptics comprise of touch, pressure, keystrokes, gait, voice, cadence, sliding movements and on-screen pressure selected from curve, angle, and distance ratio; and
wherein the attributes are selected from speed, rhythm, durations between key presses, hold latency, press latency, inter key latency, release latency, and special-keys-typing-pattern.

3. The method as claimed in claim 1, wherein the method further comprises: training, by the processor, a plurality of machine learning-based classifiers in a machine learning (ML) model based on the extracted attributes associated with the typing pattern.

4. A method for authenticating and continuously verifying a user after authenticating the user, the method comprising:
performing a training phase and an authentication phase:
the training phase (802) comprising:
capturing (804), by a processor of an electronic device, first behavioural biometrics of the user while user is operating the electronic device, wherein the behavioural biometrics comprises at least a typing pattern of the user;
extracting (806), by the processor, attributes associated with the typing pattern by pre-processing the captured first behavioural biometrics;
generating (808) a first user profile based upon the extracted attributes, wherein the first user profile comprising timestamps associated with each of the extracted attributes;
transmitting (810), by a transmitting device of the electronic device, the first user profile to an authentication server;
the authentication phase (902) comprising:
detecting that the electronic device is being accessed by the user;
capturing (904), by the processor of the electronic device, second behavioural biometrics of the user while user is operating the electronic device, wherein the second behavioural biometrics comprises at least a typing pattern of the user;
extracting (906), by the processor, attributes associated with the typing pattern by pre-processing the captured second behavioural biometrics;
receiving (908), by the electronic device, the first user profile from the authentication server;
comparing (910) the first user profile to the extracted attributes from the captured second behavioural biometrics; and
suspending (912) the electronic device access if the first user profile does not match the extracted attributes from the captured second behavioural biometrics; or
permitting (914) the user to maintain access to the electronic device if the first user profile matches the extracted attributes from the captured second behavioural biometrics; and
continuously executing (916) the authentication phase until the user stops using the electronic device.

5. The method as claimed in claim 1, wherein the typing pattern of the user comprise users'behavioural biometrics haptics of the user;
wherein the users'behavioural biometrics haptics comprise of touch, pressure, keystrokes, gait, voice, cadence, sliding movements and on-screen pressure selected from curve, angle, and distance ratio; and
wherein the attributes are selected from speed, rhythm, durations between key presses, hold latency, press latency, inter key latency, release latency, and special-keys-typing-pattern.

6. An electronic device (102) for authenticating and continuously verifying a user after authenticating the user, the electronic device comprising:
a memory storing program instructions; and
a processing unit (114) coupled to the memory and operable to execute the program instructions, which, when executed by the processing unit, cause the electronic device to:
capture behavioural biometrics (104) of the user while user is operating the electronic device, wherein the behavioural biometrics comprises at least a typing pattern of the user;
extract attributes (106) associated with the typing pattern by pre-processing the captured behavioural biometrics;
calculate timestamps associated with each of the extracted attributes;
authenticate, by the processor, using a trained neural network model, the user when the calculated timestamps at least match with one or more pre-determined timestamps associated with the user; and
continuously perform, by the processor, the authenticating step until the user stops using the user terminal.

7. The electronic device as claimed in claim 6, wherein the typing pattern of the user comprise users'behavioural biometrics haptics of the user;
wherein the users'behavioural biometrics haptics comprise of touch, pressure, keystrokes, gait, voice, cadence, sliding movements and on-screen pressure selected from curve, angle, and distance ratio; and
wherein the attributes are selected from speed, rhythm, durations between key presses, hold latency, press latency, inter key latency, release latency, and special-keys-typing-pattern.

8. The electronic device as claimed in claim 6, wherein the processing unit is configured for training a plurality of machine learning-based classifiers in a machine learning (ML) model (112) based on the extracted attributes associated with the typing pattern.

9. A system for authenticating and continuously verifying a user after authenticating the user, the system comprising:
an electronic device (102);
an authentication server (110);
a non-transitory computer-readable medium, in operable communication with the electronic device and the authentication server, for performing a training phase and an authentication phase, wherein:
the training phase comprising:
capturing, by a processor of the electronic device, first behavioural biometrics (104) of the user while user is operating the electronic device, wherein the behavioural biometrics comprises at least a typing pattern of the user;
extracting, by the processor, attributes (106) associated with the typing pattern by pre-processing the captured first behavioural biometrics;
generating a first user profile (108) based upon the extracted attributes wherein the first user profile comprising timestamps associated with each of the extracted attributes;
transmitting, by a transmitting device of the electronic device, the first user profile to the authentication server (110);
the authentication phase comprising:
detecting that the electronic device is being accessed by the user;
capturing, by the processor (114) of an electronic device, second behavioural biometrics of the user while user is operating the electronic device, wherein the second behavioural biometrics (106) comprises at least a typing pattern of the user;
extracting, by the processor, attributes (108) associated with the typing pattern by pre-processing the captured second behavioural biometrics;
receiving, by the electronic device, the first user profile (110) from the authentication server;
comparing (112) the first user profile to the extracted attributes from the captured second behavioural biometrics; and
suspending the electronic device access if the first user profile does not match the extracted attributes from the captured second behavioural biometrics; or
permitting the user to maintain access to the electronic device if the first user profile matches the extracted attributes from the captured second behavioural biometrics; and
continuously executing the authentication phase until the user stops using the electronic device.

10. The system as claimed in claim 9, wherein the typing pattern of the user comprise users'behavioural biometrics haptics of the user;
wherein the users'behavioural biometrics haptics comprise of touch, pressure, keystrokes, gait, voice, cadence, sliding movements and on-screen pressure selected from curve, angle, and distance ratio; and
wherein the attributes are selected from speed, rhythm, durations between key presses, hold latency, press latency, inter key latency, release latency, and special-keys-typing-pattern.
